(19) United States
(12) Patent Application Publication
(10) Pub. No.: US 2023/0108646 A1
(43) Pub. Date: Apr. 6, 2023

(54) POWER EFFICIENT PAGING MECHANISM WITH PAGING EARLY INDICATOR

(71) Applicant: MEDIATEK INC., Hsinchu City (TW)

(72) Inventors: Li-Chuan TSENG, Hsinchu City (TW); Wei-De WU, Hsinchu City (TW); Yi-Ju LIAO, Hsinchu City (TW); Chi-Hsuan HSIEH, Hsinchu City (TW); Chia-Chun HSU, Hsinchu City (TW)

(21) Appl. No.: 17/905,722

(22) PCT Filed: Mar. 12, 2021
(86) PCT No.: PCT/CN2021/080476

§ 371 Date: Sep. 6, 2022

Related U.S. Application Data
(60) Provisional application No. 63/045,211, filed on Jun. 29, 2020.
(60) Provisional application No. 62/988,424, filed on Mar. 12, 2020.

(51) Int. Cl. H04W 68/02; H04W 52/02

(52) U.S. Cl. CPC H04W 68/025; H04W 52/0229

(57) ABSTRACT

A method of providing early paging indication (PEI) for power consumption enhancements in a 5G/NR network is proposed. Under the novel paging reception procedure with PEI, UE can skip PO monitoring if PEI indicates negative. The UE main receiver is typically turned on in every paging cycle, for LOOP, MEAS, and PEI reception. However, if PEI indicates no paging, then UE can turn off its main receiver right after performing measurements. Since PEIs are always transmitted and are located near synchronization signal block (SSB) bursts, power saving can be achieved not only for PO monitoring but also for light sleep between the last SSB/PEI and the PO monitoring gap and state transitions, when no UE in the UE group is paged.

### CROSS REFERENCE TO RELATED APPLICATION

This application claims priority under 35 U.S.C. § 119 from U.S. Provisional Application No. 62/988,424, entitled “Power-efficient Paging Mechanism with Paging Early Indicator,” filed on Mar. 12, 2020; U.S. Provisional Application No. 63/045,211, entitled “Configurations of Paging Early Indication for Power Saving,” filed on Jun. 29, 2020, the subject matter of which is incorporated herein by reference.

### TECHNICAL FIELD

The disclosed embodiments relate generally to wireless communication systems, and, more particularly, to power efficient paging mechanism with early paging indication.

### BACKGROUND

Third generation partnership project (3GPP) and 5G New Radio (NR) mobile telecommunication systems provide high data rate, lower latency and improved system performances. In 3GPP NR, 5G terrestrial New Radio (NR) access network (includes a plurality of base stations, e.g., Next Generation Node-Bs (gNBs), communicating with a plurality of mobile stations referred as user equipment (UEs). Orthogonal Frequency Division Multiple Access (OFDMA) has been selected for NR downlink (DL) radio access scheme due to its robustness to multipath fading, higher spectral efficiency, and bandwidth scalability. Multiple access in the downlink is achieved by assigning different sub-bands (i.e., groups of subcarriers, denoted as resource blocks (RBs)) of the system bandwidth to individual users based on their existing channel condition. In LTE and NR networks, Physical Downlink Control Channel (PDCCH) is used for downlink scheduling. Physical Downlink Shared Channel (PDSCH) is used for downlink data. Similarly, Physical Uplink Control Channel (PUCCH) is used for carrying uplink control information. Physical Uplink Shared Channel (PUSCH) is used for uplink data. In addition, physical random-access channel (PRACH) is used for non-contention-based RACH.

One important use of broadcast information in any cellular systems is to set up channels for communication between the UE and the gNB. This is generally referred to as paging. Paging is a procedure the wireless network uses to find out the location of a UE, before the actual connection establishment. Paging is used to alert the UE of an incoming session (call). In most cases, the paging process happens while UE is in radio resource control (RRC) idle mode. This means that UE has to monitor whether the networking is sending any paging message to it and it has to spend some energy to run this “monitoring” process. During idle mode, a UE gets into and stays in sleeping mode defined in discontinuous reception (DRX) cycle. UE periodically wakes up and monitors PDCCH to check for the presence of a paging message. If the PDCCH indicates that a paging message is transmitted in a subframe, then the UE demodulates the paging channel to see if the paging message is directed to it.

In NR, paging reception consumes less than 2.5% of the total power. However, due to synchronization signal block (SSB) transmission scheme in NR, LOOP operations (including AGC, FTL, and TTL) and measurements (MEAS) can only be performed in certain occasions. As a result, the gap between the SSBs for LOOP/MEAS and paging occasion (PO) is longer, and UE may enter light sleep mode in the gap. If there is an indication before paging and UE monitors PO only if paging is indicated, then UE can save power consumption not only for paging reception, but also for the light sleep between the last SSB and PO gap. Therefore, a solution is sought to enable more UE power saving with indication before paging.

### SUMMARY

A method of providing early paging indication (PEI) for power consumption enhancements in a 5G/NR network is proposed. Under the novel paging reception procedure with PEI, UE can skip PO monitoring if PEI indicates negative. The UE main receiver is typically turned on in every paging cycle, for LOOP, MEAS, and PEI reception. However, if PEI indicates no paging, then UE can turn off its main receiver right after performing measurements. Since PEIs are always transmitted and are located near synchronization signal block (SSB) bursts, power saving can be achieved not only for PO monitoring but also for light sleep between the last SSB/PEI and the PO monitoring gap and state transitions, when no UE in the UE group is paged.

In one embodiment, a UE receives a paging configuration in a wireless communication system. The UE determines a Paging Early Indicator (PEI)-carrying radio frame based on the paging configuration. The paging configuration indicates a PEI offset value associated with a corresponding paging frame (PF). The UE monitors the PEI on the PEI carrying radio frame. The PEI indicates whether there is a paging opportunity (PO) in the corresponding PF. The UE monitors the PO in the corresponding PF when the PEI indicates positive paging, otherwise the UE goes to deep sleep from the reception of the PEI to the corresponding PF when the PEI indicates negative paging.

In another embodiment, a base station determines a Paging Early Indicator (PEI)-carrying radio frame for a user equipment (UE) in a wireless communication network. The base station provides a paging configuration to the UE, The paging configuration indicates a PEI offset value associated with a corresponding paging frame (PF). The base station sends a PEI to the UE on the PEI-carrying radio frame determined based on the PEI offset value. The PEI indicates whether there is a paging opportunity (PO) in the corresponding PF. The base station sends the PO with a paging message in the corresponding PF to the UE when the PEI indicates positive paging.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a procedure of paging reception with paging early indication (PEI) in a 5G New Radio (NR) network in accordance with one novel aspect.

FIG. 2 is a simplified block diagram of a UE and a base station in accordance with various embodiments of the present invention.

FIG. 3 illustrates the concept of providing PEI for additional power saving during paging reception in accordance with one novel aspect.

FIG. 4 illustrates one embodiment of describing PEI location using frame-level offset for each PF/PO in accordance with one novel aspect.

FIG. 5 illustrates a first embodiment of sequence based PEI detection in a given frame.

FIG. 6 illustrates a second embodiment of DCI-based PEI detection in a given frame.

FIG. 7 illustrates a message flow of a paging reception and connection establishment procedure in accordance with one novel aspect.

FIG. 8 is a flow chart of a method of early paging indication for power consumption enhancements from UE perspective in a 5G/NR network in accordance with one novel aspect of the present invention.

FIG. 9 is a flow chart of a method of early paging indication for power consumption enhancements from network perspective in a 5G/NR network in accordance with one novel aspect of the present invention.

### DETAILED DESCRIPTION

Reference will now be made in detail to some embodiments of the invention, examples of which are illustrated in the accompanying drawings.

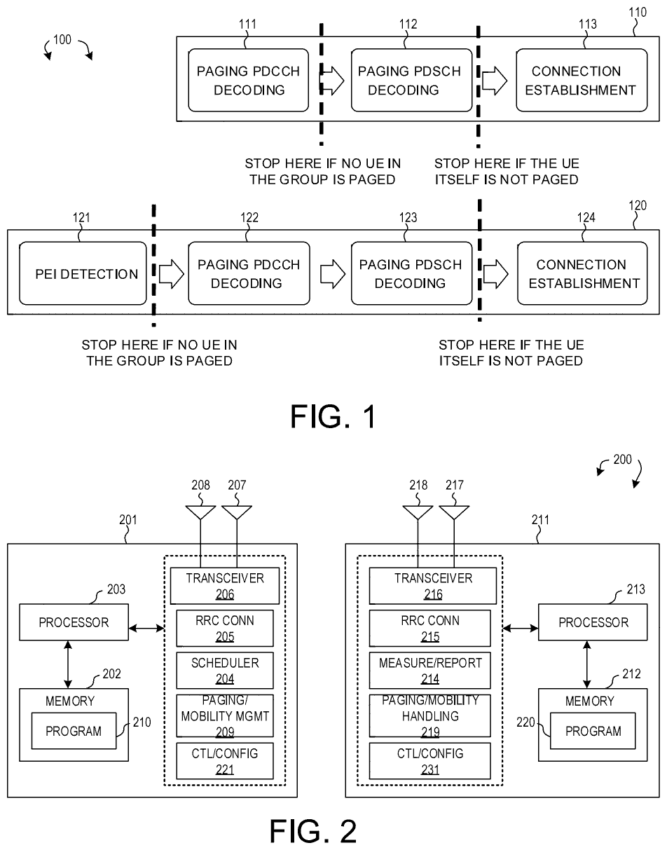

FIG. 1 illustrates a procedure of paging reception with paging early indication (PEI) in a 5G New Radio (NR) network 100 in accordance with one novel aspect. In 3GPP NR, 5G NR access network (a plurality of base stations, e.g., Next Generation Node-Bs (gNBs), communicating with a plurality of mobile stations referred as user equipment (UEs). Orthogonal Frequency Division Multiple Access (OFDMA) has been selected for NR downlink (DL) radio access scheme due to its robustness to multipath fading, higher spectral efficiency, and bandwidth scalability. In both LTE and NR networks, Physical Downlink Control Channel (PDCCH) is used for downlink scheduling. Physical Downlink Shared Channel (PDSCH) is used for downlink data. Similarly, Physical Uplink Control Channel (PUCCH) is used for carrying uplink control information. Physical Uplink Shared Channel (PUSCH) is used for uplink data. In addition, physical random-access channel (PRACH) is used for non-contention-based RACH.

One important use of broadcast information in any cellular systems is to set up channels for communication between the UE and the gNB. This is generally referred to as paging. Paging is a procedure the wireless network uses to find out the location of a UE, before the actual connection establishment. Paging is used to alert the UE of an incoming session (call). In most cases, the paging process happens while UE is in radio resource control (RRC) idle mode. This means that UE has to monitor whether the networking is sending any paging message to it and it has to spend some energy to run this “monitoring” process. During RRC idle mode, a UE gets into and stays in sleeping mode defined in discontinuous reception (DRX) cycle. UE periodically wakes up and monitors PDCCH to check for the presence of a paging message. If the PDCCH indicates that a paging message is transmitted in a subframe, then the UE demodulates the paging channel to see if the paging message is directed to it.

In NR, paging reception consumes less than 2.5% of the total power. However, due to synchronization signal block (SSB) transmission scheme in NR, LOOP operations (including AGC, FTL, and TTL) and measurements (MEAS) can only be performed in certain occasions. As a result, there is some gap between the SSBs for LOOP/MEAS and paging occasion (PO), and UE may enter light sleep mode in the gap. If there is an indication before paging and UE monitors PO only if paging is indicated, then UE can save power consumption not only for paging reception, but also for the light sleep between the last SSB and PO gap. Note that in light sleep mode, UE does not fully turn of its receiver, and thus the power consumption is higher than that in deep sleep mode, but lower than normal mode. Compared to deep sleep mode, light sleep mode requires less transition power to/from normal mode.

In accordance with one novel aspect, an indication before paging, e.g., paging early indicator (PEI), is introduced to provide power saving for paging reception. In the example of FIG. 1, top diagram 110 depicts a paging reception procedure without PEI, while bottom diagram 120 depicts a paging reception procedure with PEI. Note that a group of UEs can be associated with the same PO. During a conventional paging reception procedure 110, UE periodically wakes up and performs paging PDCCH decoding (111), if no UE in the UE group is paged, then UE stops and goes to light sleep. Otherwise, UE performs paging PDSCH decoding (112). If the UE itself is not paged, then UE stops and goes to sleep. Otherwise, UE performs connection establishment (113). During a novel paging reception procedure 120, UE periodically wakes up and checks for PEI first (121), if no UE in the UE group is paged, then UE stops and goes to deep sleep. Otherwise, UE performs paging PDCCH decoding (122) as well as paging PDSCH decoding (123). If the UE itself is not paged, then UE stops and goes to sleep. Otherwise, UE performs connection establishment (124).

Under the novel paging reception procedure 120, UE can skip PO monitoring if PEI indicates negative in step 121. The UE main receiver is turned on in every paging cycle, for LOOP, MEAS, and PEI reception. If PEI indicates no paging, then after performing required measurements, UE can turn off its main receiver and go to deep sleep until the next PEI. Note that UE is required to perform intra-or inter-frequency measurements when the serving cell is below certain threshold. Usually UE performs the required measurements when it wakes up for paging monitoring (i.e., every paging cycle), then UE will stay in deep sleep until next PEI. Since PEIs are always transmitted and are located near SSB bursts, power saving can be achieved not only for PO monitoring but also for light sleep between the last SSB/PEI and the PO monitoring gap and state transitions(e.g., the power mode transition from/to normal mode to/from light sleep mode), when no UE in the UE group is paged.

FIG. 2 is a simplified block diagram of wireless devices 201 and 211 in accordance with embodiments of the present invention. For wireless device 201 (e.g., a base station), antennae 207 and 208 transmit and receive radio signal. RF transceiver module 206, coupled with the antennae, receives RF signals from the antennae, converts them to baseband signals and sends them to processor 203. RF transceiver 206 also converts received baseband signals from the processor, converts them to RF signals, and sends out to antennae 207 and 208. Processor 203 processes the received baseband signals and invokes different functional modules and circuits to perform features in wireless device 201. Memory 202 stores program instructions and data 210 to control the operations of device 201.

Similarly, for wireless device 211 (e.g., a user equipment), antennae 217 and 218 transmit and receive RF signals. RF transceiver module 216, coupled with the antennae, receives RF signals from the antennae, converts them to baseband signals and sends them to processor 213. The RF transceiver 216 also converts received baseband signals from the processor, converts them to RF signals, and sends out to antennae 217 and 218. Processor 213 processes the received baseband signals and invokes different functional modules and circuits to perform features in wireless device 211. Memory 212 stores program instructions and data 220 to control the operations of the wireless device 211.

The wireless devices 201 and 211 also include several functional modules and circuits that can be implemented and configured to perform embodiments of the present invention. In the example of FIG. 2, wireless device 201 is a base station that includes an RRC connection handling module 205, a scheduler 204, a paging and mobility management module 209, and a control and configuration circuit 221. Wireless device 211 is a UE that includes a connection handling module 215, a measurement and reporting module 214, a paging and mobility handling module 219, and a control and configuration circuit 231. Note that a wireless device may be both a transmitting device and a receiving device. The different functional modules and circuits can be implemented and configured by software, firmware, hardware, and any combination thereof. The function modules and circuits, when executed by the processors 203 and 213 (e.g., via executing program codes 210 and 220), allow base station 201 and user equipment 211 to perform embodiments of the present invention.

In one example, the base station 201 establishes an RRC connection with the UE 211 via RRC connection handling circuit 205, schedules downlink and uplink transmission for UEs via scheduler 204, performs paging, mobility, and handover management via mobility management module 209, and provides paging, measurement, and measurement reporting configuration information to UEs via configuration circuit 221. The UE 211 handles RRC connection via RRC connection handling circuit 215, performs measurements and reports measurement results via measurement and reporting module 214, performs paging monitoring and mobility via paging and mobility handling module 219, and obtains configuration information via control and configuration circuit 231. In one novel aspect, UE 211 receives paging configuration for PEI and monitors PEI during a PEI-carrying frame. UE 211 can skip PO monitoring if PEI indicates negative to achieve power saving for PO monitoring and between the PEI and the PO monitoring gap.

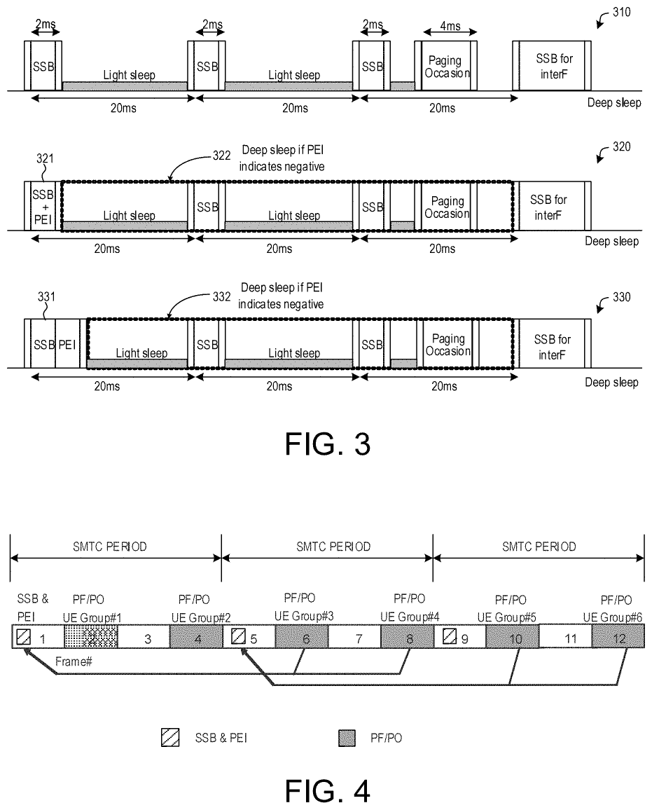

FIG. 3 illustrates the concept of providing PEI for additional power saving during paging reception in accordance with one novel aspect. Diagram 310 of FIG. 3 depicts the SSB transmission scheme in NR, where LOOP operations (including AGC, FTL, and TTL) and measurements (MEAS) can only be performed in certain occasions, e.g., during SSB bursts. UE wakes up for SSBs, e.g., every 20 ms (every 2 radio frames). UE may enter light sleep mode in the gap between the SSBs for LOOP/MEAS and paging occasion (PO). When PEI is introduced, UE can skip PO monitoring if PEI indicates negative, e.g., entering deep sleep in the gap between PEI and PO. Note that Low-SINR UEs need to wake up earlier, i.e., monitor more SSB bursts (larger NssB) before being able to decode paging message. High-SINR UEs may wake up later before PO monitoring. Therefore, if there is only one PEI for each PO, PEI needs to be relatively early in order to cover a wide range of SINR values since a PEI serves many UEs.

In NR, SMTC (SSB measurement timing configuration) is provided for SSB evaluation period determination. The location of PEI may be described for each SMTC window. PEIs are always transmitted and are located near SSB bursts, thus aiming at power saving not only PO monitoring but also light sleep and state transitions, when no UE is paged. UE may or may not need extra time for PEI monitoring in addition to SSB. In a first embodiment depicted by 320, PEI is located within the SSB burst 321. If the PEI indicates that no UEs in the UE group is paged (PEI is negative), then UE enters deep sleep in 322, e.g., entering deep sleep in the gap between PEI and PO. In a second embodiment depicted by 330, PEI is located next to the SSB burst 331. If the PEI indicates that no UEs in the UE group is paged (PEI is negative), then UE enters deep sleep in 332, e.g., entering deep sleep in the gap between PEI and PO.

FIG. 4 illustrates one embodiment of describing PEI location using frame-level offset for each PF/PO in accordance with one novel aspect. In NR, PEIs are located “near SSB” to avoid additional sleep/wakeup. The offset between PO and PEI is varying, since a paging frame (PF) containing PO needs to be mapped to SSB-carrying frame. There are two options to describe the location of PEI. In a first option, the PEI is located near the Nth SSB burst before PF/PO. In a second option, the PEI is explicitly specified in broadcast message by indicating the PEI offset for each PF/PO. For better flexibility and simpler interpretation, the second option of explicitly specifying the PEI offset is preferred.

In NR, a PF is calculated in a way similar to LTE, but the POs are not configured as subframes. Instead, the exact location of a PO is defined using paging PDCCH monitoring occasions: The starting PDCCH monitoring occasion number of the (i_s+1)th PO is the (i_s+1)th value of the firstPDCCH-MonitoringOccasionOfPO parameter; otherwise, it is equal to i_s*S, where S is the number of transmitted SSBs. Therefore, it is proposed to specify the frame-level offset for each PF, and then UE determines the starting point PEI for each PO in the PF. The frame-level PEI offset for each PF is defined as the number of radio frames between the PEI-carrying frame and the paging frame. The PEI is transmitted in an SSB-carrying frame, or another frame near SSB.

In general, a set of PEI offsets is broadcasted by the network, and the value of PEI offsets is determined by the number of radio frames in an SMTC period. UE determines which offset to use (e.g. use offset[n] if its PF is the n-th frame in the SMTC period), and subtracts the offset from the SFN of its PF to find the PEI-carrying frame. In an SMTC period, there can be K PFs, and multiple PFs can be “mapped” to one frame. K may only count really used PFs. For example, when SMTC period =40 ms, N=half of T, and K=2 (not 4). UE needs to derive the “index” of its PF in an SMTC period. The PEI of the kth PF is located in the frameOffset-PEI[k]-th frame before the PF. After applying the frame-level PEI offset, UE can find a SSB/PEI-carrying frame to monitor the PEI.

In the example of FIG. 4, assume one PO per PF. POs in Frame #6 (for UE group #3) and Frame #8 (for UE group #4) find their PEI in Frame #1, and POs in Frame#10 (for UE group #5) and Frame #12 (for UE group #6) find their PEI in Frame #5. For each SMTC period, there are two PFs, and the corresponding frame-level offset for PEI is {5, 7}. That is, for PO in Frame #6, the PEI frame-level offset is 5, UE can find its corresponding PEI in radio frame #1 (6−5=1); for PO in Frame #8, the PEI frame-level offset is 7, UE can find its corresponding PEI in radio frame #1 (8−7=1). Similarly, for PO in Frame #10, the PEI frame-level offset is 5, UE can find its corresponding PEI in radio frame #5 (10−5=5); for PO in Frame #12, the PEI frame-level offset is 7, UE can find its corresponding PEI in radio frame #5 (12−7=5).

After locating the PEI-carrying frame, UE needs to find the exact starting and ending points of PEI monitoring interval. There are two types of PEI for NR. A first type of PEI is sequence-based PEI, and a second type of PEI is DCI-based PEI. UE needs to perform synchronization for PEI detection and decoding in Idle mode. Furthermore, for multi-beam operation, a PEI serves a group of UEs with different serving beams. PEI needs to be repeated on multiple beams. The same PEIs repeated on multiple beams is referred to as a PEI burst.

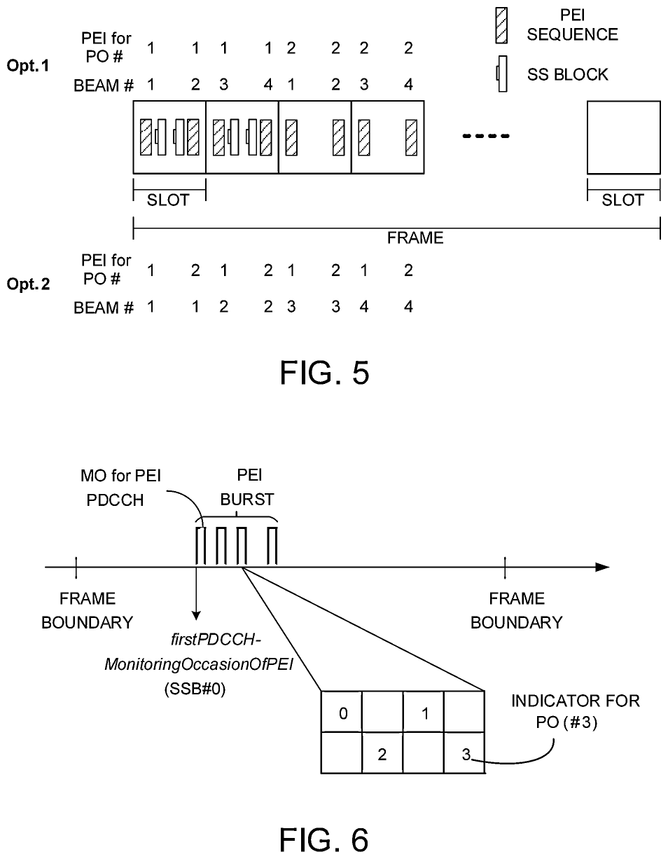

FIG. 5 illustrates a first embodiment of sequence based PEI detection in a given frame. In sequence-based PEI, PEI may be defined as orthogonal sequences. A PEI burst consists of S (#SSB transmitted) PEI sequences, which is transmitted on different beams and indicates the paging of one PO. Assume the PEIs of N_{PO} POs are mapped to this frame, and Nbeam SS blocks (SSBs) are transmitted, there are N_{PO}*N_{beam} PEIs, and the location of each PEI is pre-defined or configured as a set of OFDM symbols. In the example of FIG. 5, SMTC period=20 ms; S=4 (4 SSBs/beams transmitted); and N=T (every frame is PF) and Ns=1 (one PO per PF), which result in two POs per SMTC period. In each SMTC period, there are 8 PEI sequences. Note that the location of each PEI sequence should be pre-defined or configured by network. UE is provided with the starting OFDM symbols, and the UE monitors a fixed number of symbols for each PEI.

There are two options for indexing PEIs. In Opt1, PEI is received in a Beam-first manner, where every Nbeam PEI locations correspond to Nbeam SSBs for a PO. For example, 4 PEIs for PO#1, then 4 PEIs for PO#2, where the 4 PEIs correspond to 4 beams. In a Opt2, the PEIs may be received in a PO-first manner, where every N_{PO} PEI locations correspond to N_{PO} POs for the same beam. For example, 2 PEIs for beam#1, then 2 PEIs for beam#2, and so on. The 2 PEIs correspond to 2 POs. Sequence-based PEI has the advantage of easier detection. PEI sequences can be detected by separated circuits, i.e., without turning on the main receiver. PEI sequences can also be used for synchronization purpose. However, PEI transmission may occupy too much radio resources and may not be suitable in case of larger number of POs or beams.

FIG. 6 illustrates a second embodiment of DCI-based PEI detection in a given frame. In DCI-based PEI, PEI may be signaled using DCI and transmitted in given search space. DCI-based PEI can be configured by the network, including 1) the CRC of PEI-DCI is scrambled by RNTI, 2) the PEI-DCI size, size of the indication bitmap, and 3) the position of indication for each PO in the SMTC period. UE monitors PEIs as bitmaps on specific monitoring occasions (MO). Assume the PEIs for N_{PO} POs are mapped to this frame, and Nbeam SS blocks (SSBs) are transmitted, there are Nbeam PEIs, and in each PEI, N_{PO} bits are used to indicate the paging in N_{PO} POs.

UE determines the MO for bitmap-based PEIs on each beam in different ways. In the example of FIG. 6, SMTC period=20 ms; S=4 (4 SSBs/beams transmitted); and N=T (every frame is PF) and Ns=2 (two POs per PF), which result in four POs per SMTC period. In Opt1, Network configures the first PDCCH monitoring occasion of PEI in the given frame, and PEI occupies S (#SSB transmitted) consecutive MOs. UE determines the first MO for a set of PEIs according to network configurations (use MO#0 by default). The first MO corresponding to SSB#0, and subsequent MOs correspond to SSB#1, #2, and so on as shown in FIG. 6. In Opt2, The MO for each beam (SSB index) is configured by the network or calculated by pre-defined formula, in the PEI-carrying frame.

Note that synchronization is needed before decoding DCI. In low-SINR scenario, this means that UE may need to monitor multiple SSB burst(s) before decoding DCI, meaning less saved power. One DCI can indicate the paging status of multiple POs (e.g., one bit for a PO in the DCI bitmap), or even a sub-groups of UEs if UE-group PEI is introduced. This means more efficient radio resource usage. For DCI-based method, UE behavior needs to be defined or configured when UE does not detect or successfully decode PEI-DCI. However, considering the uncertainty of DCI detection in RRC Idle mode, it is preferred that UE always monitor the PO if PEI-DCI is configured but not detected or not successfully decoded.

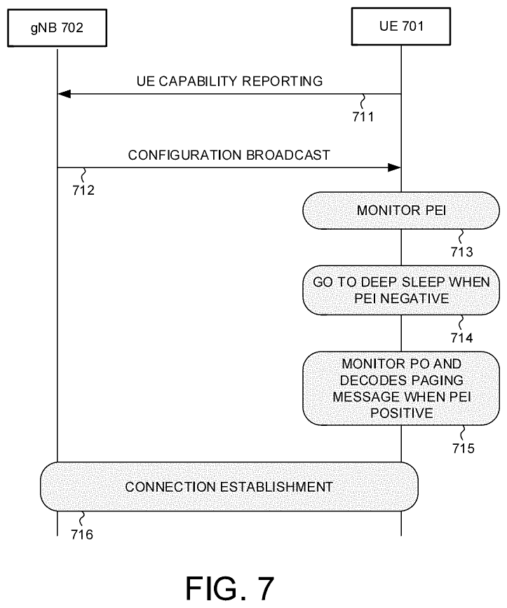

FIG. 7 illustrates a message flow of a paging reception and connection establishment procedure in accordance with one novel aspect of the present invention. In step 711, UE 701 reports to the network 702 its minimum required gap between PO and corresponding PEI as UE capability. In step 712, UE 701 receives broadcast info containing paging configuration. The paging configuration indicates whether and where the network sends PEI and paging messages. In step 713, UE 701 monitors PEI at pre-defined locations and performs measurements. A group of UEs associated with the same PO monitors the same PEI, which corresponds to a PO, or to multiple POs monitored by the same group of UEs. The UE determines the radio frame that carries PEI using a frame-level PEI offset, and determines the starting point and duration of PEI monitoring based on network configurations. Monitoring duration can be the same as SMTC window (by default), or a longer value configured by the network. In step 714, UE 701 goes to deep sleep during the gap from PEI to PO if the PEI indicates negative paging. In step 715, UE 701 monitors PO and decodes the paging message inside, if the PEI indicates positive paging. In step 716, UE 701 performs connection establishment with network 702 if its UE ID is included in the paging message.

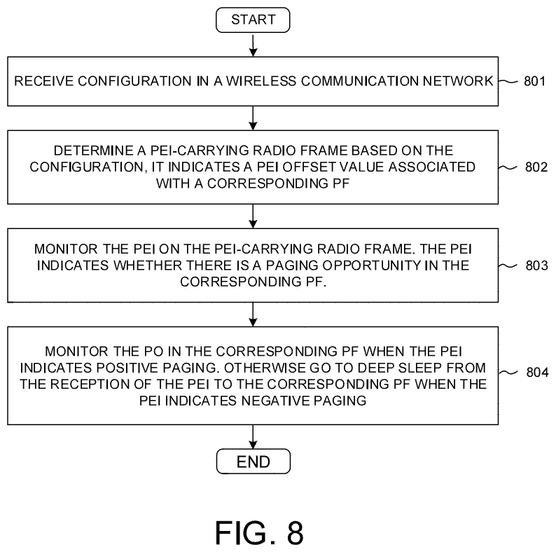

FIG. 8 is a flow chart of a method of early paging indication for power consumption enhancements from UE perspective in a 5G/NR network in accordance with one novel aspect. In step 801, a UE receives a configuration in a wireless communication network. In step 802, the UE determines a Paging Early Indicator (PEI)-carrying radio frame based on the configuration. The configuration indicates a PEI offset value associated with a corresponding paging frame (PF). In step 803, the UE monitors the PEI on the PEI-carrying radio frame. The PEI indicates whether there is a paging opportunity (PO) in the corresponding PF. In step 804, the UE monitors the PO in the corresponding PF when the PEI indicates positive paging, otherwise the UE goes to deep sleep from the reception of the PEI to the corresponding PF when the PEI indicates negative paging. In one embodiment, the PEI offset is a frame-level offset that indicates a number of radio frames with respect to the corresponding PF. The PEI is a sequence or a bitmap that corresponds to a group of UEs that the UE belongs to.

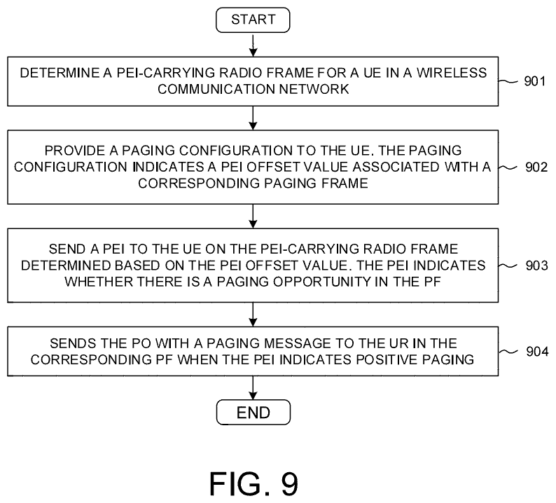

FIG. 9 is a flow chart of a method of early paging indication for power consumption enhancements from network perspective in a 5G/NR network in accordance with one novel aspect. In step 901, a base station determines a Paging Early Indicator (PEI)-carrying radio frame for a user equipment (UE) in a wireless communication network. In step 902, the base station provides a paging configuration to the UE. The paging configuration indicates a PEI offset value associated with a corresponding paging frame (PF). In step 903, the base station sends a PEI to the UE on the PEI-carrying radio frame determined based on the PEI offset value. The PEI indicates whether there is a paging opportunity (PO) in the corresponding PF. In step 904, the base station sends the PO with a paging message to the UE in the corresponding PF when the PEI indicates positive paging. In one embodiment, the PEI offset is a frame-level offset that indicates a number of radio frames with respect to the corresponding PF. The PEI is a sequence or a bitmap that corresponds to a group of UEs that the UE belongs to.

Although the present invention is described above in connection with certain specific embodiments for instructional purposes, the present invention is not limited thereto. Accordingly, various modifications, adaptations, and combinations of various features of the described embodiments can be practiced without departing from the scope of the invention as set forth in the claims.

1. A method, comprising:
receiving a paging configuration by a user equipment (UE) in a wireless communication network;
determining a Paging Early Indicator (PEI)-carrying radio frame based on the paging configuration, wherein the configuration indicates a PEI offset value associated with a corresponding paging frame (PF);
monitoring the PEI on the PEI-carrying radio frame, wherein the PEI indicates whether there is a paging opportunity (PO) in the corresponding PF; and
monitoring the PO in the corresponding PF when the PEI indicates positive paging, otherwise going to deep sleep from the reception of the PEI to the corresponding PF when the PEI indicates negative paging.

2. The method of claim 1, wherein the PEI offset is a frame-level offset that indicates a number of radio frames with respect to the corresponding PF.

3. The method of claim 2, wherein the frame-level PEI offset is broadcasted to the UE and is determined based on a number of radio frames in a synchronization signal block (SSB) measurement timing configuration (SMTC) period.

4. The method of claim 1, wherein the UE turns off a main radio frequency (RF) receiver during the deep sleep without waking up to monitor any PO.

5. The method of claim 1, wherein the PEI is a sequence, and wherein the sequence corresponds to a group of UEs that the UE belongs to.

6. The method of claim 5, wherein the PEI is received in a beam-first manner or in a PO-first manner.

7. The method of claim 1, wherein the PEI is a bitmap in a downlink control information (DCI), and wherein the bitmap corresponds to a group of UEs that the UE belongs to.

8. The method of claim 7, wherein the UE monitors the PEI on specific monitoring occasions (MO) according to the paging configuration.

9. A user equipment (UE), comprising:
a receiver that receives a paging configuration in a wireless communication system;
a controller that determines a Paging Early Indicator (PEI)-carrying radio frame based on the paging configuration, wherein the configuration indicates a PEI offset value associated with a corresponding paging frame (PF); and
a paging handling circuit that monitors the PEI on the PEI carrying radio frame, wherein the PEI indicates whether there is a paging opportunity (PO) in the corresponding PF, wherein the UE monitors the PO in the corresponding PF when the PEI indicates positive paging, otherwise goes to deep sleep from the reception of the PEI to the corresponding PF when the PEI indicates negative paging.

10. The UE of claim 9, wherein the PEI offset is a frame-level offset that indicates a number of radio frames with respect to the corresponding PF.

11. The UE of claim 10, wherein the frame-level PEI offset is broadcasted to the UE and is determined based on a number of radio frames in a synchronization signal block (SSB) measurement timing configuration (SMTC) period.

12. The UE of claim 9, wherein the UE turns off a main radio frequency (RF) receiver during the deep sleep without waking up to monitor any PO.

13. The UE of claim 9, wherein the PEI is a sequence, and wherein the sequence corresponds to a group of UEs that the UE belongs to.

14. The UE of claim 13, wherein the PEI is received in a beam-first manner or in a PO-first manner.

15. The UE of claim 9, wherein the PEI is a bitmap in a downlink control information (DCI), and wherein the bitmap corresponds to a group of UEs that the UE belongs to.

16. The UE of claim 15, wherein the UE monitors the PEI on specific monitoring occasions (MO) according to the paging configuration.

17. A method, comprising:
determining a Paging Early Indicator (PEI)-carrying radio frame for a user equipment (UE) by a base station in a wireless communication system;
providing a paging configuration to the UE, wherein the paging configuration indicates a PEI offset value associated with a corresponding paging frame (PF);
sending a PEI to the UE on the PEI-carrying radio frame determined based on the PEI offset value, wherein the PEI indicates whether there is a paging opportunity (PO) in the corresponding PF; and
sending the PO with a paging message in the corresponding PF to the UE when the PEI indicates positive paging.

18. The method of claim 17, wherein the PEI offset is a frame-level offset that indicates a number of radio frames with respect to the corresponding PF.

19. The method of claim 18, wherein the frame-level PEI offset is broadcasted to the UE and is determined based on a number of radio frames in a synchronization signal block (SSB) measurement timing configuration (SMTC) period.

20. The method of claim 17, wherein the PEI is a sequence or a bitmap that corresponds to a group of UEs that the UE belongs to.
